(19) United States
(12) Patent Application Publication
(10) Pub. No.: US 2012/0215485 A1
(43) Pub. Date: Aug. 23, 2012

(54) PROGRAMMING METHOD FOR A COORDINATE MEASURING MACHINE AND COMPUTING DEVICE THEREOF

(75) Inventors: CHIH-KUANG CHANG, Tu-Cheng (TW); XIN-YUAN WU, Shenzhen City (CN); MIN WANG, Shenzhen City (CN)

(73) Assignees: HON HAI PRECISION INDUSTRY CO., LTD, Tu-Cheng (TW); HONG FU JIN PRECISION INDUSTRY (ShenZhen) CO.,LTD., Shenzhen City (CN)

(21) Appl. No.: 13/273,245

(22) Filed: Oct. 14, 2011

(30) Foreign Application Priority Data
Feb. 23, 2011 (CN) 201110043415.3

(51) Int. Cl. G01B 5/008

(52) U.S. Cl. 702/150

(57) ABSTRACT

In a programming method, a number of points measured on a product are roughly fitted into/matched with one or more geometrical elements, and a fitting value of the geometrical elements are output to a first data list. The method records the storing positions of the geometrical elements having fitting values that are within a predetermined tolerance value in a second data list, and obtains a best geometrical element type of the product by determining geometrical element types that correspond to each of the storing positions recorded in the second data list using a matching condition. After the best geometrical element type from the first data list is obtained, the method generates a measurement program and displays the measurement program on a display device.

### BACKGROUND

1. Technical Field

Embodiments of the present disclosure generally relate to measurement programs, and more particularly to a programming method for a coordinate measuring machine and a computing device thereof.

2. Description of Related Art

Coordinate measuring machines (CMMs) are used in the industry to measure manufactured parts. The measurements of the manufactured part can determine if the manufactured part meets design specifications and can provide information for improvements in process control. Programming speed of CMMs can be a bottleneck in the manufacturing process. In networked systems, online programming is a popular programming method. However, the online programming is slow, and the CMM(s) may remain idle during programming An alternative solution is to design measurement programs for manufactured parts according to design drawings, as programming with design drawings is much faster. When programming the design drawings, a user needs to set parameters for geometrical elements of the manufactured parts, and the geometrical elements cannot be inspected before measurement. Therefore, an improved system and method is desirable to address the aforementioned issues.

### BRIEF DESCRIPTION OF THE DRAWINGS

FIG. 1 is a block diagram of one embodiment of a computing device including a program unit.

FIG. 2 is a block diagram of function modules of the program unit in FIG. 1.

FIG. 3 is a flowchart illustrating one embodiment of a programming method for a coordinate measurement machine.

FIG. 4 is a detailed description of block S02 in FIG. 3, for obtaining the best geometric element type.

### DETAILED DESCRIPTION

In general, the word “module,” as used hereinafter, refers to logic embodied in hardware or firmware, or to a collection of software instructions, written in a programming language, such as, for example, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

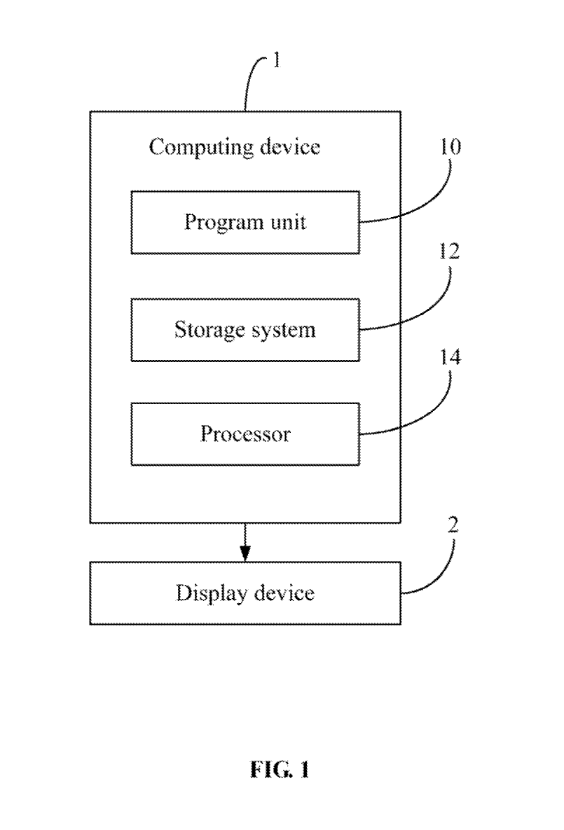

FIG. 1 is a block diagram of one embodiment of an computing device 1 including a program unit 10. In the embodiment, the functions of the program unit 10 are implemented by the computing device 1. From a file that stores a number of dimensional points measured on a product, the program unit 10 can find, import, and apply a best geometric element type in order to measure the dimensional points of the product, relate the points actually measured to a geometric element matching the best geometric element type, display or draw the geometric element, and generate a measurement program (that is, create a program for measuring each product, or a set of measurements for a particular type of product, to include the order in which measurements are to be taken, to take the required measurements, and to record the measurement data) according to attributes of the best geometric element type and the measuring points. In the embodiment, the measurement program can be written in a programming language, such as, for example, Java, C, or assembly. The measurement program is executable by the computing device 1. The measurement program is a software program which is able to automatically measure other products of the same type.

In one embodiment, the computing deice 1 may be a computer, a server, a portable electronic device, or any other electronic device that includes a storage system 12, and at least one processor 14. In one embodiment, the storage system 12 may be a magnetic or an optical storage system, such as a hard disk drive, an optical drive, a compact disc, a digital video disc, a tape drive, or other suitable storage medium. The processor 14 may be a central processing unit including a math co-processor, for example.

The computing device 1 is electronically connected to a display device 2. The display device 2 is configured for displaying the measurement program that includes a measuring process and the results thereof.

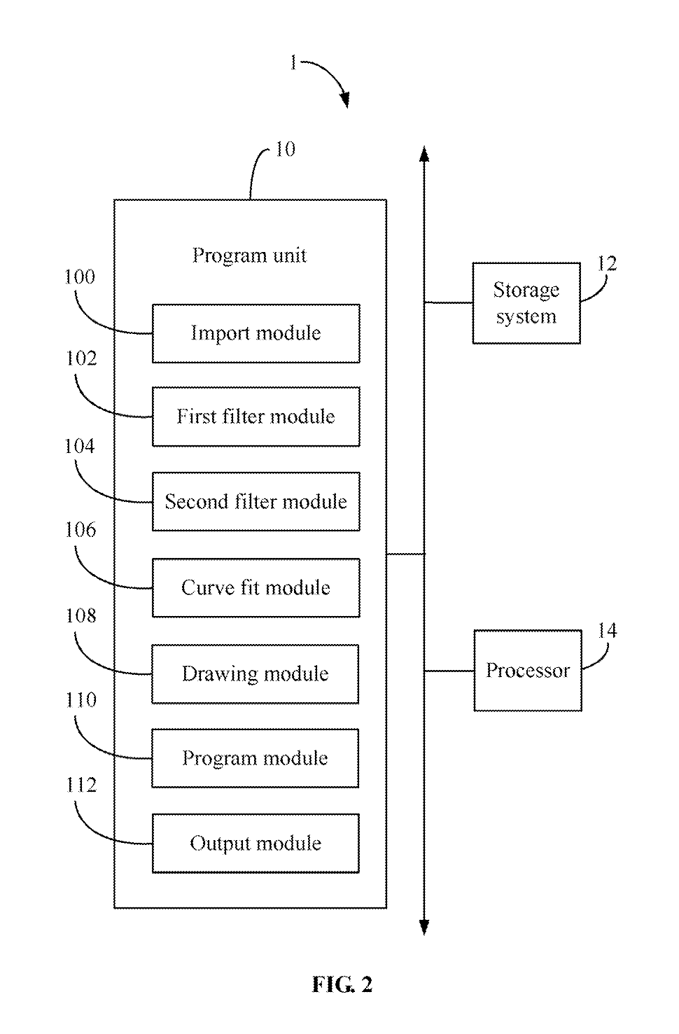

FIG. 2 is a block diagram of function modules of the program unit 10 in FIG. 1. In one embodiment, the program unit 10 includes an import module 100, a first filter module 102, a second filter module 104, a curve fit module 106, a drawing module 108, a program module 110, and an output module 112. Each of the modules 100-112 may be a software program including one or more computerized instructions that are stored in the storage system 12 and executed by the processor 14.

The import module 100 imports all the measuring points of a product from a file storing the points measured on the product, to a point storing list applicable to that product or type of product. The point storing list is a list that stores measuring points of one type of product, and attributes of the measuring points. In the embodiment, the point storing list is stored in the storage system 12.

The first filter module 102 firstly arranges the measuring points into one or more geometrical elements using a curve fitting method. The curve fitting method is the process of constructing a curve, or mathematical function of the measuring points. Each of the geometrical elements corresponds to a fitting value. The fitting value is an average distance of the geometrical element and an ideal graphic of the product. In theory, one product can match one geometrical element. When the number of the measuring points is small, the first filter module 100 may be able to fit the measuring points into several geometrical elements.

The first filter module 102 outputs the fitting value of each of the geometrical elements to a first data list. In the embodiment, the first data list includes a serial number, a geometrical element type, and attributes of each of the geometrical elements. The serial number dictates the position and location of any geometrical element which has been stored in the first data list. The attributes of each of the geometrical elements is information concerning the construction and form of each of the geometrical elements, such as dimensional data and relationships within each of the geometrical elements. For example, if the geometrical element is a straight line, the attributes includes the starting point and the end point of that straight line. If the geometrical element is a circle, the attributes includes the midpoint of the circle, and the calculable radius of the circle.

In one embodiment, the geometrical element type can be a point, a line, a circle, a flat surface, a plane, a circle, a cylinder, or the like. For example, if the imported measuring points are three points on the same plane, the first filter module 102 can determine that the three points may fit into or onto a flat surface, a plane or a circle.

The second filter module 104 compares the fitting values with a predetermined tolerance value, to obtain the geometrical elements whose fitting values are within the predetermined tolerance value(s). The second filter module 104 further records the storing positions of the geometrical elements whose fitting values are within the predetermined tolerance value(s) in a second data list, and obtains a best geometrical element type by determining the geometrical element types corresponding to each of the storing positions using a matching condition.

In one embodiment, the matching condition is used for filtering and retrieving the best geometrical element type from the geometrical element types saved in the first data list. For example, if the total number of the measuring points is one, the best geometrical element type may be a point; if the total number of the measuring points is larger than one and the measuring points are in a straight line, the best geometrical element type may be a straight line; if the angle between a normal vector suggested by the measuring points (a vector that is perpendicular to the measuring points in a flat surface) and a normal vector of the geometrical element is within a predetermined value, the measuring points may be in a same surface, the best geometrical element type may be a plane; if a normal vector of the measuring points is perpendicular to a normal vector of the geometrical element, and the measuring points are in a plane, the best geometrical element type may be a circle; or if a normal vector of the measuring points is perpendicular to a normal vector of the geometrical element, and not all of the measuring points are in a plane, the best geometrical element type may be a cylinder.

In the embodiment, if none of the fitting values in the first data list is within the predetermined tolerance value(s), the second filter module 104 determines the geometrical element type which corresponds to a minimum fitting value of the first data list as the best geometrical element type. That is, the second filter module 104 takes an element which is the next closest fit to the product.

The curve fit module 106 uses a best fit method to fit the measuring points to a most suitable geometrical element. The type of the most suitable geometrical element is the best geometrical element type. The best fit method is the process of constructing a curve, or mathematical function of the measuring points, that has the best fit to the measuring points, possibly subject to constraints. In one embodiment, the best fit method is used for selecting a best fit match of the measuring points to a geometrical element, which may express the best representation of the shape(s) of the product.

The drawing module 108 infills and completes the shape(s) of the product by connecting the measuring points consisted of the most suitable geometrical element, and displays the product consisted by the measuring points.

The program module 110 obtains the attributes concerning the best geometrical element type from the first data list, and generates a measurement program for the best geometrical element type according to the attributes and the measuring points.

The output module 112 displays the measurement program including the process which it follows on the display device 2, and stores the measurement program into the storage system 12.

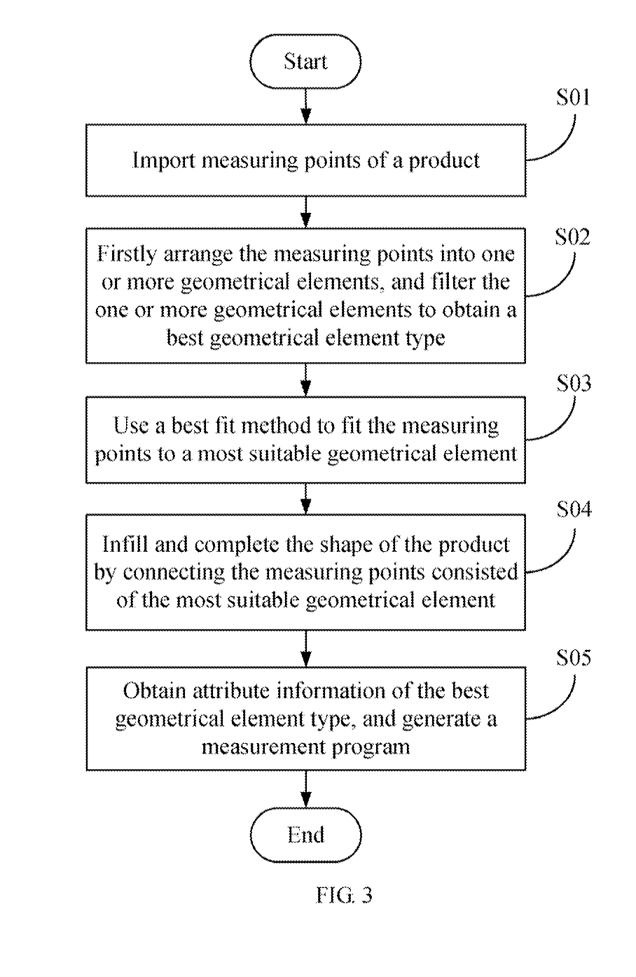

FIG. 3 is a flowchart illustrating one embodiment of a programming method for a coordinate measurement machine using the computing device 1 of FIG. 1. The method can be performed by the execution of a computer-readable program by the at least one processor 12. Depending on the embodiment, in FIG. 2, additional blocks may be added, others removed, and the ordering of the blocks may be changed.

In block S01, the import module 100 imports the measuring points of a product to a point storing list applicable to that product or type of product. In the embodiment, the point storing list is stored in the storage system 12.

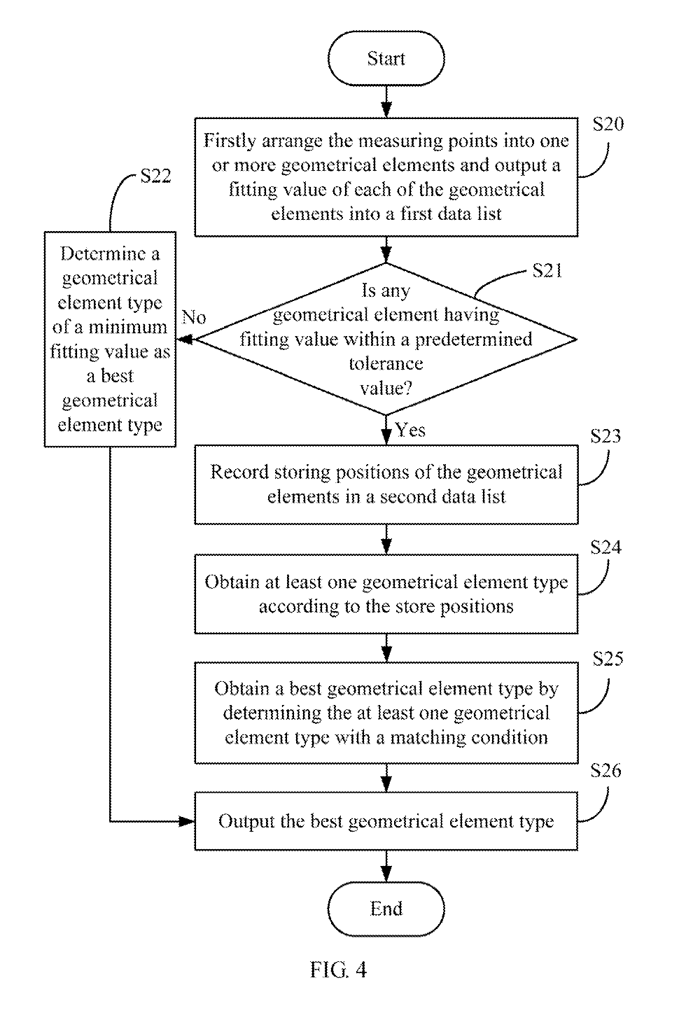

In block S02, the first filter module 102 firstly arranges the measuring points into one or more geometrical elements using a curve fitting method, and the second filter module 104 further filters the one or more geometrical elements, to obtain a best geometrical element type. Details of block S02 are described below in FIG. 4.

In block S03, the curve fit module 106 uses a best fit method to fit the measuring points to a most suitable geometrical element according to the best geometrical element type. In one embodiment, the best fit method is a process of constructing a curve, or a mathematical function of the measuring points, that has the best fit to the measuring points, possibly subject to constraints.

In block S04, the drawing module 108 infills and completes the shape(s) of the product by connecting the measuring points consisted of the most suitable geometrical element, and displays the product consisted by the measuring points.

In block S05, the program module 110 obtains attributes of the best geometrical element type from the first data list, and generates a measurement program for the best geometrical element type according to the attributes and the measuring points. The output module 112 displays the measurement program including the process which it follows on the display device 2, and stores the measurement program into the storage system 12.

FIG. 4 is a detailed description of block S02 in FIG. 3, which is for obtaining a best geometric element type.

In block S20, the first filter module 102 firstly arranges the measuring points into one or more geometrical elements using a curve fitting method, and outputs the fitting value of each of the geometrical elements to the first data list. Each of the geometrical elements corresponds to a fitting value. In the embodiment, the first data list further includes a serial number, a geometrical element type, and attributes for each of the geometrical elements. The serial number dictates the position and location of a geometrical element which has been stored in the first data list. The geometrical element type can be a point, a line, a circle, a flat surface, a plane, a circle, a cylinder, or the like.

In block S21, the second filter module 104 compares the fitting values with a predetermined tolerance value(s), and determines whether there is any geometrical element whose fitting value is within the predetermined tolerance value(s). If no geometrical element whose fitting value is within the predetermined tolerance value, block S22 is implemented. If there is any geometrical element whose fitting value is within the predetermined tolerance value, block S23 is implemented. For example, the predetermined tolerance value can be set as 0.01 millimeters.

In block S22, the second filter module 104 finds a minimum fitting value from the first data list, and determines that the geometrical element type which corresponds to the minimum fitting value is the best geometrical element type.

In block S23, the second filter module 104 records the storing positions of the geometrical elements whose fitting values are within the predetermined tolerance value in a second data list.

In block S24, the second filter module 104 obtains at least one geometrical element type from the second data list according to the storing positions recorded in the second data list.

In block S25, the second filter module 104 obtains a best geometrical element type for the product by determining the at least one geometrical element type using a matching condition. As mentioned above, the matching condition is used for filtering and retrieving the best geometrical element type from the geometrical element types saved in the first data list. For example, if the total number of the measuring points is one, the best geometrical element type may be a point; if the total number of the measuring points is larger than one and the measuring points are in a straight line, the best geometrical element type may be a line; if the angle between a normal vector suggested by the measuring points (a vector that is perpendicular to the measuring points in a flat surface) and a normal vector of the geometrical element is within a predetermined value, the best geometrical element type may be a plane; if a normal vector of the measuring points is perpendicular to a normal vector of the geometrical element, and the measuring points are in a plane, the best geometrical element type may be a circle; or if a normal vector of the measuring points is perpendicular to a normal vector of the geometrical element, and not all of the measuring points are in a plane, the best geometrical element type may be a cylinder.

In block S26, the second filter module 104 outputs the best geometrical element type on the display device 2.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-implemented programming method for a coordinate measurement machine, the method comprising:
arranging measuring points of an object into one or more geometrical elements using a curve fitting method, and outputting a fitting value of each of the geometrical elements into a first data list, the first data list comprising a geometrical element type for each of the geometrical elements and attributes of each of the geometrical elements;
recording storing positions of the geometrical elements having fitting values that are within a predetermined tolerance value in a second data list;
obtaining a best geometrical element type for the object by determining the geometrical element types corresponding to each of the storing positions recorded in the second data list using a matching condition;
obtaining the attributes of the best geometrical element type from the first data list, and generating a measurement program for the best geometrical element type according to the attributes and the measuring points; and
displaying the measurement program on a display device.

2. The method as described in claim 1, wherein the best geometrical element type step is obtained by:
determining a point as the best geometrical element type, upon a condition that a total number of the measuring points is one;
determining a line as the best geometrical element type, upon a condition that the total number of the measuring points is larger than one, and the measuring points are in a straight line;
determining a plane as the best geometrical element type, upon a condition that an angel between a normal vector of the measuring points and a normal vector of the geometrical element is within a predetermined value;
determining a circle as the best geometrical element type, upon a condition that a normal vector of the measuring points is perpendicular to a normal vector of the geometrical element, and the measuring points are in a plane; or
determining a cylinder as the best geometrical element type, upon a condition that a normal vector of the measuring points is perpendicular to a normal vector of the geometrical element, and not all of the measuring points are in a plane.

3. The method as described in claim 1, further comprising:
using a best fit method to fit the measuring points to a most suitable geometrical element according to the best geometrical element type; and
drawing the shape of the product by connecting the measuring points consisted of the most suitable geometrical element, and displaying the most suitable geometrical element and the measuring points.

4. The method as described in claim 1, further comprising:
upon a condition that no fitting value in the first data list is within the predetermined tolerance value, determining the geometrical element type corresponding to a minimum fitting value of the first data list as the best geometrical element type.

5. A computing device, comprising:
at least one processor;
a storage system; and
one or more modules that are stored in the storage system and executed by the at least one processor, the one or more modules comprising:
a first filter module operable to arrange measuring points of an object into one or more geometrical elements using a curve fitting method, and outputting a fitting value of each of the geometrical elements into a first data list, the first data list comprising a geometrical element type for each of the geometrical elements and attributes of each of the geometrical elements;
a second filter module operable to record storing positions of the geometrical elements having fitting values that are within a predetermined tolerance value in a second data list, and obtain a best geometrical element type for the object by determining the geometrical element types corresponding to each of the storing positions recorded in the second data list using a matching condition;
a program module operable to obtain the attributes of the best geometrical element type from the first data list, and generating a measurement program for the best geometrical element type according to the attributes and the measuring points; and
an output module operable to display the measurement program on a display device that is electronically connected to the computing device.

6. The computing device as described in claim 5, further comprising an import module operable to import the measuring points from a file to a point storing list.

7. The computing device as described in claim 5, wherein the best geometrical element type is obtained by means of:
determining a point as the best geometrical element type, upon a condition that a total number of the measuring points is one;
determining a line as the best geometrical element type, upon a condition that the total number of the measuring points is larger than one, and the measuring points are in a straight line;
determining a plane as the best geometrical element type, upon a condition that an angel between a normal vector of the measuring points and a normal vector of the geometrical element is within a predetermined value;
determining a circle as the best geometrical element type, upon a condition that a normal vector of the measuring points is perpendicular to a normal vector of the geometrical element, and the measuring points are in a plane; or
determining a cylinder as the best geometrical element type, upon a condition that a normal vector of the measuring points is perpendicular to a normal vector of the geometrical element, and not all of the measuring points are in a plane.

8. The computing device as described in claim 5, further comprising:
a curve fit module operable to use a best fit method to fit the measuring points to a most suitable geometrical element according to the best geometrical element type; and
a drawing module operable to draw the shape of the product by connecting the measuring points consisted of the most suitable geometrical element, and displaying the most suitable geometrical element and the measuring points.

9. The computing device as described in claim 5, wherein the second filter module is further operable to determine the geometrical element type corresponding to a minimum fitting value of the first data list as the best geometrical element type, upon a condition that no fitting value in the first data list is within the predetermined tolerance value.

10. A non-transitory storage medium having stored thereon instructions that, when executed by a processor of a computing device, causes the computing device to perform a programming method for a coordinate measurement machine, the method comprising:
arranging measuring points of an object into one or more geometrical elements using a curve fitting method, and outputting a fitting value of each of the geometrical elements into a first data list, the first data list comprising a geometrical element type for each of the geometrical elements and attributes of each of the geometrical elements;
recording storing positions of the geometrical elements having fitting values that are within a predetermined tolerance value in a second data list;
obtaining a best geometrical element type for the object by determining the geometrical element types corresponding to each of the storing positions recorded in the second data list using a matching condition;
obtaining the attributes of the best geometrical element type from the first data list, and generating a measurement program for the best geometrical element type according to the attributes and the measuring points; and
displaying the measurement program on a display device.

11. The non-transitory storage medium as described in claim 10, wherein the best geometrical element type step is obtained by means of:
determining a point as the best geometrical element type, upon a condition that a total number of the measuring points is one;
determining a line as the best geometrical element type, upon a condition that the total number of the measuring points is larger than one, and the measuring points are in a straight line;
determining a plane as the best geometrical element type, upon a condition that an angel between a normal vector of the measuring points and a normal vector of the geometrical element is within a predetermined value;
determining a circle as the best geometrical element type, upon a condition that a normal vector of the measuring points is perpendicular to a normal vector of the geometrical element, and the measuring points are in a plane; or
determining a cylinder as the best geometrical element type, upon a condition that a normal vector of the measuring points is perpendicular to a normal vector of the geometrical element, and not all of the measuring points are in a plane.

12. The non-transitory storage medium as described in claim 10, wherein the method further comprises:
using a best fit method to fit the measuring points to a most suitable geometrical element according to the best geometrical element type; and
drawing the shape of the product by connecting the measuring points consisted of the most suitable geometrical element, and displaying the most suitable geometrical element and the measuring points.

13. The non-transitory storage medium as described in claim 10, wherein the method further comprises:
upon a condition that no fitting value in the first data list is within the predetermined tolerance value, determining the geometrical element type corresponding to a minimum fitting value of the first data list as the best geometrical element type.
